(19) United States
(12) Patent Application Publication
(10) Pub. No.: US 2022/0182633 A1
(43) Pub. Date: Jun. 9, 2022

(54) Method and Apparatus of Latency Reduction for Chroma Residue Scaling

(71) Applicant: MEDIATEK INC., Hsinchu City (TW)

(72) Inventors: Zhi-Yi LIN, Hsinchu City (TW); Tzu-Der CHUANG, Hsinchu City (TW); Ching-Yeh CHEN, Hsinchu City (TW); Chih-Wei HSU, Hsinchu City (TW)

(21) Appl. No.: 17/436,836

(22) PCT Filed: Mar. 13, 2020
(86) PCT No.: PCT/CN2020/079287

§ 371 Date: Sep. 7, 2021

Related U.S. Application Data
(60) Provisional application No. 62/870,757, filed on Jul. 4, 2019.
(60) Provisional application No. 62/866,710, filed on Jun. 26, 2019.
(60) Provisional application No. 62/863,333, filed on Jun. 19, 2019.
(60) Provisional application No. 62/837,773, filed on Apr. 24, 2019.
(60) Provisional application No. 62/822,866, filed on Mar. 23, 2019.
(60) Provisional application No. 62/818,799, filed on Mar. 15, 2019.

(51) Int. Cl. H04N 19/132; H04N 19/30; H04N 19/186; H04N 19/176

(52) U.S. Cl. CPC H04N 19/132; H04N 19/176; H04N 19/186; H04N 19/30

(57) ABSTRACT

A method and apparatus of video decoding are disclosed. According to one method, the chroma residue scaling factors are derived based on neighboring prediction or reconstructed luma samples of the collocated luma block, where the neighboring prediction or reconstructed luma samples of the collocated luma block correspond to samples among M samples along a top boundary of the collocated luma block and N samples along a left boundary of the collocated luma block. Chroma scaling is applied to chroma residual samples of the chroma residual block according to the chroma residue scaling factors derived. In another method, the chroma residue scaling factors are derived based on one or more reconstructed luma samples outside the collocated luma processing data unit. In another method, the chroma residue scaling factors are signaled in or parsed from APS (Adaptation Parameter Set) of the bitstream.

### CROSS REFERENCE TO RELATED APPLICATIONS

The present invention claims priority to U.S. Provisional Patent Application, Ser. No. 62/818,799, filed on Mar. 15, 2019, U.S. Provisional Patent Application, Ser. No. 62/822,866, filed on Mar. 23, 2019, U.S. Provisional Patent Application, Ser. No. 62/837,773, filed on Apr. 24, 2019, U.S. Provisional Patent Application, Ser. No. 62/863,333, filed on Jun. 19, 2019, U.S. Provisional Patent Application, Ser. No. 62/866,710, filed on Jun. 26, 2019 and U.S. Provisional Patent Application, Ser. No. 62/870,757, filed on Jul. 4, 2019. The U.S. Provisional Patent Application is hereby incorporated by reference in its entirety.

### TECHNICAL FIELD

The present invention relates to video coding for color video data, where luma mapping is applied to the luma component. In particular, the present invention discloses techniques for deriving and/or signaling one or more chroma scaling factors for chroma residual scaling.

### BACKGROUND

The Versatile Video Coding (VVC) is an emerging video coding standard being developed by the Joint Video Experts Team, a collaborative team formed by the ITU-T Study Group 16 Video Coding Experts Group and ISO/IEC JTC1 SC29/WG11 (Moving Picture Experts Group, MPEG). The VVC is based on the HEVC (High Efficient Video Coding) video standard with improved and new coding tools. For example, reshaping process is a new coding tool adopted in VTM-4.0 (VVC Test Model Ver. 4.0). The reshaping process is also referred as LMCS (Luma Mapping and Chroma Scaling). When reshaping is applied, the video samples are coded and reconstructed in the reshaped domain before loop filtering. The reshaped-domain reconstructed samples are converted to the original domain by using the inverse reshaping. The loop-filtered original-domain reconstructed samples are stored in the decoded picture buffer. For Inter mode, the motion compensated (MC) predictors are converted to the reshaped domain by using the forward reshaping. FIG. 1 shows the example of reshaping process at a decoder side.

As shown in FIG. 1, the bitstream is processed by CABAC (context-adaptive binary arithmetic coding) decoder (i.e., CABAC⁻¹), inverse quantization (i.e., Q⁻¹) and inverse transform (T⁻¹) to derive reconstructed luma residue Yᵣₑₛ. The reconstructed luma residue is provided to the luma reconstruction block 120 to generate reconstructed luma signal. For Intra mode, the predictor comes from the Intra prediction block 130. For Inter mode, the predictor comes from the motion compensation block 140. Since reshaping is applied to the luma signal at the encoder side, the forward reshaping 150 is applied the predictor from the motion compensation block 140 before the predictor is provided to the reconstruction block 120. The inverse reshaping 160 is applied to the reconstructed luma signal from the reconstruction block 120 to recover the un-shaped reconstructed luma signal. Loop filter 170 is then applied to the un-shaped reconstructed luma signal before the signal is stored in the decoded picture buffer (DPB) 180.

When reshaping is applied, the chroma residue scaling is also applied. Chroma residue scaling compensates for luma signal interaction with the chroma signal, as shown in FIG. 2. In FIG. 2, the upper part corresponds to the luma decoding and the lower part corresponds to the chroma decoding.

Chroma residue scaling is applied at the TU level according to the following equations at the encoder side and the decoder side respectively:

Encoder side: C_{ResScale}=C_{Res}*C_{scale}=C_{Res}/C_{ScaleInv} (1)

Decoder side: C_{Res}=C_{ResScale}/C_{Scale}=C_{ResScale}*C_{ScaleInv} (2)

In the above equations, C_{Res} is the original chroma residue signal and C_{ResScale} is the scaled chroma residue signal. C_{Scale} is a scaling factor calculated using FwdLUT (i.e., forward look-up table) for Inter mode predictors and is converted to its reciprocal C_{ScaleInv} to perform multiplication instead of division at the decoder side, thereby reducing implementation complexity. The scaling operations at both encoder and decoder side are implemented with fixed-point integer arithmetic with the following equation:

c′=sign(c)*((abs(c)*s+2^{CSCALE_FP_PREC-1})>>CSCALE_FP_PREC) (3)

In the above equation, c is chroma residue, s is chroma residue scaling factor from cScaleInv[pieceIdx], pieceIdx is decided by the corresponding average luma value of the TU, and CSCALE_FP_PREC is a constant value to specify precision. For deriving the scaling factor, the predictor of the whole TU is used. The value of C_{ScaleInv} is computed in the follow steps:
(1) If Intra mode, compute average of Intra predicted luma values; if Inter mode, compute average of forward reshaped Inter predicted luma values. In other words, the average luma value avgY′_{TU} is computed in the reshaped domain.
(2) Find index idx, where avgY′_{TU} belongs to inverse mapping PWL.
(3) C_{ScaleInv}=cScaleInv[idx]

The steps to derive the chroma scaling factor C_{ScaleInv} are performed by block 210 in FIG. 2. The derived chroma scaling factor C_{ScaleInv} is used to convert the scaled chroma residue, which is reconstructed through CABAC (context-adaptive binary arithmetic coding) decoding (i.e., CABAC⁻¹), inverse quantization (i.e., Q⁻¹) and inverse transform (T⁻¹). Reconstruction block 220 reconstruct the chroma signal by adding the predictor to the reconstructed chroma residue. For Intra mode, the predictor comes from the Intra prediction block 230. For Inter mode, the predictor comes from the motion compensation block 240. Loop filter 270 is then applied to the reconstructed chroma signal before the signal is stored in the chroma decoded picture buffer (DPB) 280.

FIG. 3A and FIG. 3B illustrates an example of luma mapping. In FIG. 3A, a 1:1 mapping is shown where the output (i.e., reshaped luma) is the same as the input. Since the histogram of the luma samples usually is not flat, using intensity shaping may help to improve performance in the RDO (rate-distortion optimization) sense. The statistics of the luma samples is calculated for an image area, such as a picture. A mapping curve is then determined according to the statistics. Often, a piece-wise linear (PWL) mapping curve is used. FIG. 3B illustrates an example of piece-wise linear (PWL) mapping having 3 segments, where two neighboring segments have different slopes. The dashed line 340 corresponds to the 1:1 mapping. If samples ranging from 0 to 340 have larger spatial variance and the number of occurrences is smaller, the input range 0-340 is mapped to a smaller output range (i.e., 0-170), as shown in segment 310 of FIG. 3B. If samples ranging from 340 to 680 have smaller spatial variance and the number of occurrences is larger, the input range 340-680 is mapped to a larger output range (i.e., 170-850), as shown in segment 320 of FIG. 3B. If samples ranging from 680 to 1023 have larger spatial variance and the number of occurrences is smaller, the input range 680-1023 is mapped to a smaller output range (i.e., 850-1023), as shown in segment 330 of FIG. 3B. FIG. 3B is intended to illustrate a simple PWL mapping. In practice, the PWL mapping may have more or less segments.

Intra Sub-Block Partition (ISP) and Sub-Block Transform (SBT)

To generate better Intra mode predictors, the Intra sub-block partition (ISP) can be applied. When the ISP is applied, the luma component is divided into multiple sub-TBs. The sub-TBs are reconstructed one by one. For each sub-TU, the reconstructed sample of neighboring sub-TB can be used as the neighboring reconstructed samples for Intra prediction. For chroma component TB, it will not be divided into multiple sub-TBs as luma does.

Similar to ISP, the sub-block transform (SBT) can be applied to Inter mode. When SBT is applied, only part of the CU data are transformed. For example, the current can be divided into two partitions by horizontal split or vertical split. Only one of the partition can be used for transform coding. The residue of the other partition is set to zero. For example, the CU is divided into two TUs or four TUs. Only one of the TU has non-zero coefficient.

Signaling of LMCS Parameters

The syntax table of LMCS parameters being considered by the VVC is shown in Table

TABLE 1

| lmcs_data () { | Descriptor |
|---|---|
| lmcs_min_bin_idx | ue(v) |
| lmcs_delta_max_bin_idx | ue(v) |
| lmcs_delta_cw_prec_minus1 | ue(v) |
| for ( i = lmcs_min_bin_idx; i <= LmcsMaxBinIdx; i++ ) { | |
| lmcs_delta_abs_cw[ i ] | u(v) |
| if ( lmcs_delta_abs_cw[ i ] ) > 0 ) | |
| lmcs_delta_sign_cw_flag[ i ] | u(1) |
| } | |
| } | |

In the above syntax table, the semantics of the syntaxes are defined as follows:
lmcs_min_bin_idx specifies the minimum bin index of the PWL (piece-wise linear) model for luma mapping
lmcs_delta_max_bin_idx specifies the delta value between 15 and the maximum bin index LmcsMaxBinIdx used in the lmcs. The value should be in the range of 1 to 15, inclusive.
lmcs_delta_cw_prec_minus1 plus 1 is the number of bits used for the representation of the syntax lmcs_delta_abs_cw[i].
lmcs_delta_abs_cw[i] is the absolute delta codeword value for the ith bin.
lmcs_delta_sign_cw_flag[i] is the sign of the variable lmcsDeltaCW[i].

Variable lmcsDeltaCW[i] is derived as follows:

lmcsDeltaCW[i]=(1−2*lmcs_delta_sign_cw_flag[i])*lmcs_delta_abs_cw[i].

Variables lmcsCW[i] with i=0 . . . 15 specify the number of codewords for each interval in the mapped domain. It can be derived as follows:

```
-OrgCW = (1 << BitDepthY ) / 16
-For i = 0 . . . lmcs_min_bin_idx − 1, lmcsCW[ i ] is set equal 0.
-For i = lmcs_min_bin_idx...LmcsMaxBinIdx, the following applies:
  -lmcsCW[ i ] = OrgCW + lmcsDeltaCW[ i ]
  -The value of lmcsCW[ i ] shall be in the range of (OrgCW>>3) to
(OrgCW<<3 − 1), inclusive.
-For i = LmcsMaxBinIdx + 1 . . . 15, lmcsCW[ i ] is set equal 0.
```

To represent the PWL model of the reshaping curve, three variables LmcsPivot[i] with i=0 . . . 16, ScaleCoeff[i] with i=0 . . . 15, and InvScaleCoeff[i] with i=0 . . . 15, are derived as follows:

```
      LmcsPivot[ 0 ] = 0;
for( i = 0; i <= 15; i++ ) {
  LmcsPivot[ i + 1] = LmcsPivot[ i ] + lmcsCW[ i ]
  ScaleCoeff[ i ] = ( lmcsCW[ i ] * (1 << SCALE_FP_PREC) + (1 <<
(Log2(OrgCW) − 1))) >> (Log2(OrgCW))
    if ( lmcsCW[ i ] = = 0 )
      InvScaleCoeff[ i ] = 0
    else
      InvScaleCoeff[ i ] = OrgCW * (1 << SCALE_FP_PREC) /
      lmcsCW[ i ]
}
```

In the above derivation, SCALE_FP_PREC is a constant value to specify precision.

In the LMCS process, due to the dependence on the corresponding luma data, the latency for chroma residue scaling may have negative impact on the processing speed. Therefore, it is desirable to develop methods and apparatus to reduce the latency for chroma residue scaling.

### SUMMARY

A method and apparatus of video decoding are disclosed. According to one method of the present invention, a current chroma residual block is received. One or more chroma residue scaling factors are derived based on neighboring prediction or reconstructed luma samples of the collocated luma block, wherein the neighboring prediction or reconstructed luma samples of the collocated luma block associated with the current chroma residual block correspond to samples among M samples along a top boundary of the collocated luma block and N samples along a left boundary of the collocated luma block, and wherein the M and N are positive integers. Chroma scaling is applied to chroma residual samples of the current chroma residual block according to said one or more chroma residue scaling factors derived.

In one embodiment, the neighboring prediction or reconstructed luma samples of the collocated luma block correspond to the M samples along the top boundary of the collocated luma block. In another embodiment, the neighboring prediction or reconstructed luma samples of the collocated luma block correspond to the N samples along the left boundary of the collocated luma block. In yet another embodiment, the neighboring prediction or reconstructed luma samples of the collocated luma block correspond to both the M samples along the top boundary of the collocated luma block and the N samples along the left boundary of the collocated luma block.

In one embodiment, a boundary sample at a top-left position of the collocated luma block is used to derive said one or more chroma residue scaling factors if the boundary sample at the top-left position of the collocated luma block is available. If the boundary sample at the top-left position of the collocated luma block is not available, a left boundary sample along the left boundary of the collocated luma block or a top boundary sample along the top boundary of the collocated luma block is used to derive said one or more chroma residue scaling factors.

According to another method, chroma residual data associated with a current chroma processing data unit in a picture are received, where the picture is divided into multiple non-overlapped processing data units and each processing data unit comprises a luma processing data unit and one or more chroma processing data units. One or more chroma residue scaling factors are derived based on one or more reconstructed luma samples outside the collocated luma processing data unit associated with the current chroma processing data unit. Chroma scaling is then applied to chroma residual samples of the current chroma processing data unit according to said one or more chroma residue scaling factors derived. According to a variation of this method, the chroma residue scaling factors are derived based on one or more reconstructed luma samples from a first coding unit (CU) covering a top-left position of the collocated luma processing data unit.

In one embodiment, said one or more reconstructed luma samples outside the first coding unit (CU) covering the collocated luma processing data unit correspond to one or more reconstructed luma samples of one or more previously coded luma processing data units. In another embodiment, said one or more reconstructed luma samples of said one or more previously coded luma processing data units correspond to one or more reconstructed luma samples along a top boundary of the first coding unit (CU) covering the collocated luma processing data unit, one or more reconstructed luma samples along a left boundary of the first coding unit (CU) covering the collocated luma processing data unit, or both.

In one embodiment, the reconstructed luma samples outside the collocated luma processing data unit correspond to one or more reconstructed luma samples of one or more previously coded luma processing data units. For example, the reconstructed luma samples of said one or more previously coded luma processing data units correspond to one or more reconstructed luma samples along a top boundary of the collocated luma processing data unit, one or more reconstructed luma samples along a left boundary of the collocated luma processing data unit, or both.

In yet another method, one or more chroma residue scaling factors are signaled in an APS (Adaptation Parameter Set) level of a video bitstream in an encoder side or parsed from the APS level of the video bitstream at a decoder side.

### BRIEF DESCRIPTION OF THE DRAWINGS

FIG. 1 illustrates an exemplary block diagram of a video decoder incorporating luma reshaping process.

FIG. 2 illustrates an exemplary block diagram of a video decoder incorporating luma reshaping process and chroma scaling.

FIG. 3A illustrates an example of 1:1 luma mapping, where the output (i.e., reshaped luma) is the same as the input.

FIG. 3B illustrates an example of piece-wise linear (PWL) luma mapping having 3 segments.

FIG. 4 illustrates an example of deriving chroma scaling factors based on the reference reconstructed luma samples along the VPDU top boundary, left boundary or both according to an embodiment of the present invention.

FIG. 5 illustrates an example of deriving chroma scaling factors based on the reference reconstructed luma sample TL, A or L position according to an embodiment of the present invention.

FIG. 6 illustrates a flowchart of an exemplary decoding system for deriving one or more chroma residue scaling factors based on neighboring prediction or reconstructed luma samples of the collocated luma block according to an embodiment of the present invention.

FIG. 7 illustrates a flowchart of another exemplary decoding system for deriving one or more chroma residue scaling factors based on one or more reconstructed luma samples outside the collocated luma processing data unit according to an embodiment of the present invention.

FIG. 8 illustrates a flowchart of an exemplary coding system, where one or more chroma residue scaling factors are signaled in an APS (Adaptation Parameter Set) level of a video bitstream in an encoder side or parsed from the APS level of the video bitstream at a decoder side according to an embodiment of the present invention.

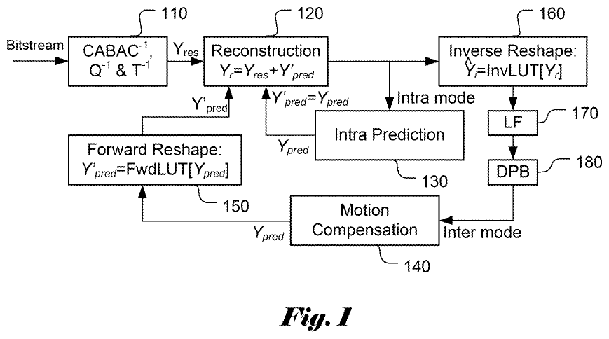

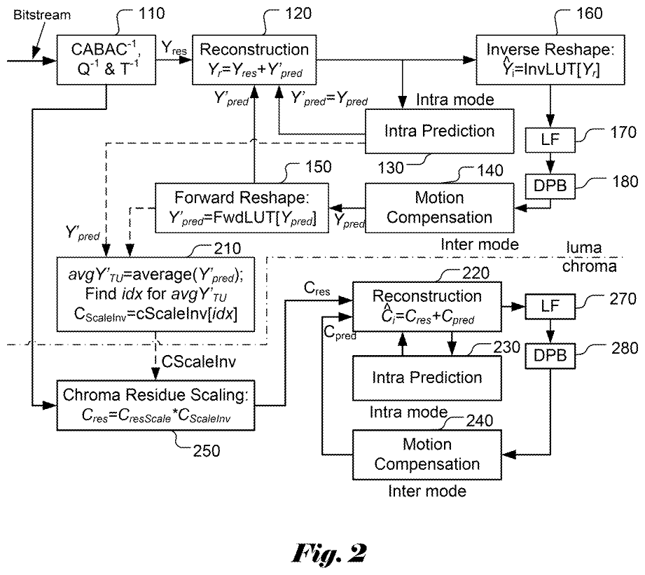

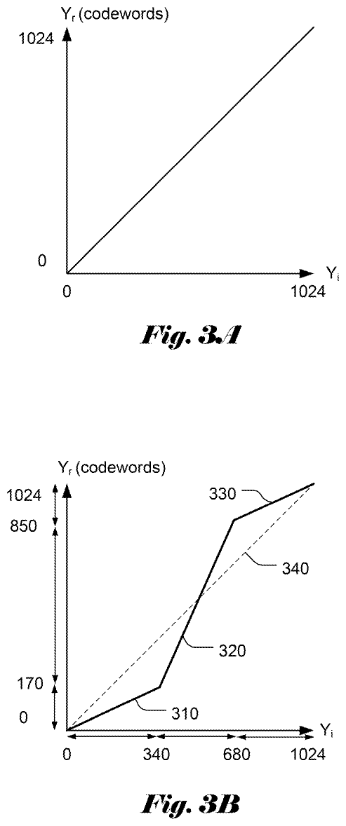

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

In the chroma residue scaling, for a chroma TU, all the corresponding luma predictors are used to derive one single scaling factor. The chroma sample reconstruction cannot be processed before deriving the scaling factor. It introduces new data dependency for the cross-component process, which results in longer latency for the chroma sample reconstruction. In VVC, several decoder side tools are introduced to refine the luma predictor for better coding efficiency. These kind of coding tools will also increase the reconstruction loop critical path. In Inter and Intra mode predictions, the prediction samples of a CU/PU/TU can be divided into multiple M×N blocks, and the blocks can be processed in sequential or in parallel.

In one embodiment, to reduce the latency for chroma sample reconstruction, for a CU/PU/TU, it only uses its top-left K×L luma samples (e.g. luma predictors or luma reconstructed samples or luma residue) or top-left M luma samples are used to derive the one or more chroma residue scaling factors. The K and L can be equal to 1, 2, 4, 8, 16, 32, or 64. The one or more scaling factors are used for the whole chroma TUs. For example, the top-left 16×15 luma samples are used. In another example, the top-left 1×1 luma sample is used. In another example, the top-left 256 luma samples are used. In another example, the top-left 1 luma sample is used. In another example, if the width and height of the luma CU/TU is larger than or equal to 16, the top-left 16×16 luma samples are used; otherwise, at most 256 luma samples at the top-left are used. In one example, when ISP is applied, only the top-left K×L block or the top-left M samples of the first ISP sub-TB is used to derive the chroma residue scaling factor. In another example, when SBT is applied, only the top-left K×L block or the top-left M samples of the TU with non-zero coefficients are used to derive the scaling factor. In another embodiment, only part of the corresponding luma samples are used to derive the chroma residual scaling factor. For example, part of the inner collocated luma CT/TU/PU boundary samples, such as part of the top-row and part of left-column of the inner collocated luma CT/TU/PU boundary samples, are used to derive the chroma residual scaling factor.

In another embodiment, in order to reduce the latency for chroma sample reconstruction for a CU/PU/TU, only sample(s) (i.e., corresponding luma samples or called collocated luma samples) along the current TB's neighboring boundary are used to derive the one or more chroma residue scaling factors. The sample(s) can be prediction sample(s) or reconstructed sample(s) of the neighboring blocks. In one embodiment, M samples along the top boundary are used to derive the one or more chroma residue scaling factors. In one embodiment, N samples along the left boundary are used to derive the one or more chroma residue scaling factors. In one embodiment, M samples along the top boundary and N samples along the left boundary are used to derive the one or more chroma residue scaling factors. Here the M and N can be 1, 2, 4, 8, 16, 32, or 64. In another embodiment, the sample at the top-left position of the L-shape boundary is used to derive the one or more chroma residue scaling factors. In another embodiment, if the top-left neighboring sample is available, the sample is used. Otherwise, one of the top neighboring sample or one of the left neighboring sample is used. In one example, if none of the above sample is available, the top-left sample in the collocated luma block is used. The one or more scaling factors are used to the whole chroma TUs.

In another embodiment, in order to reduce the latency for the chroma sample reconstruction when the chroma residue scaling is applied, it is proposed to divide the chroma TU into sub-blocks, such as K×L sub-blocks or the sub-blocks with block size equal to M. The K and L can be 2, 4, 8, 16 or 32; M can be 4, 8, 16, 32, 64, 128, 256, 512, or 1024. For each K×L chroma residue sub-block, one or more scaling factors are derived. Different K×L chroma residue sub-blocks can have different scaling factors. For example, for an M×N block, where M is larger than K (i.e., the width threshold) and N is smaller than L (i.e., the height threshold), this M×N block is divided into M/K (K×N) blocks.

In another embodiment, the chroma residue scaling is not applied when the chroma residue TU size/area/width/height is smaller than a first threshold or larger than a second threshold. For example, the chroma residue scaling is disabled when the TU size smaller than or equal to 8 or 16 or 64. In another example, the chroma residue scaling is disabled when the TU width or height is smaller than or equal to 2 or 4 or 8 or 16. In another example, the chroma residue scaling is disabled when the TU size larger than or equal to 16, 64, 256 or 1024. In another example, the chroma residue scaling is disabled when the TU width or height is larger than or equal to 8 or 16 or 32. In another example, for some prediction modes, the chroma residue scaling is disabled. For example, the chroma residue scaling is disabled for the block with DMVR mode, BIO mode, LIC mode, diffusion mode enabled or a combination of these modes enabled.

DMVR (Decoder-Side Motion Vector Refinement) is a new coding tool developed in recent years. DMVR derives MV refinement information at the decoder side in order to improve coding performance. BIO is another new coding tool developed in recent years. BIO derives the sample-level motion refinement based on the assumptions of optical flow and steady motion, where a current pixel in a B-slice (bi-prediction slice) is predicted by one pixel in reference picture 0 and one pixel in reference picture 1. LIC (Local Illumination Compensation) is a method to perform Inter prediction using neighboring samples of the current block and a reference block. It is based on a linear model using a scaling factor and an offset.

In one embodiment, when ISP is applied, only part of the luma sub-TBs are used to derive the chroma residue scaling factor. For example, only the first luma TB is used to derive the chroma residue scaling factor. Using the first luma TB for generating the scaling factor can reduce latency of chroma sample reconstruction. In another example, only the last luma TB is used to derive the chroma residue scaling factor.

In another embodiment, when ISP is applied, each luma sub-TB can be treated as an individual TB. For each sub-TB, it can calculate its own chroma residue scaling factor. The proposed method above can be also applied, e.g. dividing the each luma sub-TB into several K×L sub-blocks and deriving a scaling factor for each sub-blocks. For the chroma TB, even though it is not divided into sub-TBs like the luma does when doing transform, the chroma TB is also divided into multiple sub-regions when doing chroma residue scaling. Each sub-region corresponds to one luma TB; each sub-region corresponds to one or more luma sub-TBs; or one more chroma sub-regions correspond to one luma sub-TB. For each chroma sub-region, it can be further split to multiple sub-blocks if the luma sub-TB is divided to multiple sub-blocks for deriving the scaling factors.

In another embodiment, when SBT is applied, only the luma partition that with non-zero coefficient is used to derive the chroma residue scaling factor. The used luma partition can be divided into sub-blocks for deriving the scaling factor. In another embodiment, when SBT is applied, the luma samples of the whole CU can be used to derive one or more scaling factors.

In another embodiment, the luma samples of a CU (not TU or TB) are used to derive the chroma residue scaling factor. When ISP is applied, the whole luma CU samples are used to derive the chroma residue scaling factor. For example, the luma CU samples can be divided into sub-blocks to derive different scaling factors for different sub-blocks. The sub-blocks can cross the ISP sub-TB boundaries.

In another embodiment, the chroma residue scaling factor derivation can be different for transform applied or not applied (e.g. transform skip). The values/factor/constant or the equation can be different for the chroma residue scaling factor derivation. In another embodiment, the chroma residue scaling factor derivation can be different for different prediction modes or different residue energy levels.

In the encoder side, the scaling factor derivation usually includes deriving the lambda for the quantization parameter. In one embodiment, the whole TU prediction data are used to derive the lambda value. For chroma residual scaling, the TU is still divided into sub-blocks. Each sub-block can derive its own scaling factor.

In the BIO and DMVR processes, it will encounter the same kind of process problem. For example, for the BIO process, the TU/PU/CU-level SAD (sum of absolute differences) calculation is performed. The BIO process can be disabled if the calculated cost is small enough. For DMVR process, it is not a hardware friendly design if the whole CU/PU/TU is used for deriving one MV difference (MVD). Therefore, it is proposed to align the BIO with DMVR, or even align the BIO and/or DMVR with chroma residue scaling process, which divides the current block into K×L blocks. For example, for both BIO and DMVR processes, the current block is divided into K×L blocks. For each K×L block, it can calculate its cost for BIO early termination decision or it can derive its own MVD by using the DMVR process. In another example, for the BIO or the DMVR processes, the current block are divided into K×L blocks for performing BIO and DMVR processes, where the K×L (in luma sample precision) is the same size as the basic unit of the chroma residue scaling process.

In another embodiment, different modes can use reference luma samples in different positions.

In one embodiment, for blocks that can reference neighboring reconstructed samples for the prediction process, the reference luma samples for the scale value derivation are from the neighboring reconstructed samples or the reference boundary samples that are used to generate the predictor of the current CU or TU. For example, if current block is Intra prediction mode, the referenced luma samples is the top-left, top, or left reference boundary samples of the current CU. Therefore, for Intra sub-partition prediction (ISP) mode, the chroma residuals scaling value is derived using the top-left, top, or left of the L-shape boundary reconstructed samples of the current CU/TU (not the sub-partition TU). In another example, if current block is Intra prediction mode, the referenced luma samples are the top-left reference boundary samples of current TU. Therefore, for Intra sub-partition prediction (ISP) mode, the chroma residuals scaling value is derived using the top-left, top, or left of the L-shape boundary reconstructed samples of the current TU (sub-partition). The top-left L-shape boundary reconstructed sample can be one sample.

In another example, if the current CU is Inter prediction mode, but is predicted by combined Inter/Intra modes (CIIP) or other prediction methods that need the neighboring reconstructed samples, the referenced luma samples can be the reference boundary reconstructed samples or the reference boundary samples that are used to generate the predictor of the current CU or TU (e.g. use the top-left neighboring reconstructed sample) as described above. As known in the field, CIIP is yet another coding tool developed in recent years. CIIP uses a weighted average of the Inter and Intra prediction signals to obtain the CIIP prediction.

In another embodiment, if the current block is an Inter prediction mode, the reference luma sample(s) can be the top-left luma prediction samples of the current CU or TU.

In one embodiment, if it is CITP mode, then the reference luma samples are the top-left luma prediction sample of the Inter predictor.

In another embodiment, if the current block is an Inter prediction mode except for the CIIP mode, the reference luma sample(s) can be the top-left luma prediction samples of current CU or TU. In this embodiment, the blocks coded in CIIP mode are treated as Intra prediction mode, and any of the above methods related to Intra prediction mode can be applied.

In another embodiment, if the current block is the IBC mode, the decision of the reference luma samples is the same as the Inter prediction mode. As is known in the field, IBC (Intra Block Copy) is a new coding tool developed in recent years. IBC is similar to the Inter prediction mode. However, instead of using reference pixels in previously coded frame, IBC using reference pixels in the current frame.

In another embodiment, if the current block is the IBC mode, the decision of the reference luma samples is the same as the Intra prediction mode.

When the reference luma sample or samples are the prediction samples of the current CU or TU, different numbers of samples can be used as described in the above embodiments.

In one embodiment, the above embodiments for Intra and Inter prediction mode can be combined.

In one embodiment, for Intra prediction mode and CIIP mode, the reference luma sample is the top-left boundary reference sample used to generate the Intra predictor, and for Inter prediction mode except for CITP mode, the reference luma sample is the top-left luma prediction sample.

In one embodiment, for Intra prediction mode, the reference luma sample is the top-left boundary reference sample used to generate Intra predictor, and for Inter prediction mode except for CIIP mode, the reference luma sample is the top-left luma prediction sample. For CIIP mode, the reference luma samples is the top-left luma prediction sample of the Inter predictor. In other words, the prediction samples are blended with Intra prediction samples before being used.

In one embodiment, for the Intra prediction mode and CITP mode, the reference luma sample is the top-left, top, or left (the first available) boundary reconstructed sample, and for Inter prediction mode except for CITP mode, the reference luma sample is the top-left luma prediction sample. In other words, the prediction samples are blended with Intra prediction samples before being used.

In another example, only the top-left reconstructed sample is used.

If the reference sample is not available, then scaling factor is set to a default value. In one embodiment, the default value is equal to (1<<PREC), where PREC is the prediction for chroma scaling.

In one embodiment, for Intra prediction mode, the reference luma sample is the top-left, top, or left (the first available) boundary reconstructed sample, and for Inter prediction mode except for CIIP mode, the reference luma sample is the top-left luma prediction sample. For CIIP mode, the reference luma samples is the top-left luma prediction sample of the Inter predictor. In other words, the prediction samples are blended with Intra prediction samples before being used.

Mode Constraints and Conditionally Disallow Chroma Split within a Root Block

In another embodiment, a root block is determined and the luma component of this root block can be further partitioned into smaller blocks. According to this embodiment, whether the chroma components of the root block can be further split is decided according to the prediction mode of the luma blocks within the same root block.

In previous methods, three cases of the definition of “same mode” are listed as below:

case 1. the same mode means all of the blocks within the root block must be Intra prediction mode, or Inter prediction mode, or IBC mode.

case 2. the same mode means all of the blocks within the root block must be Intra prediction mode, or Inter/IBC prediction mode.

case 3. the same mode means all of the blocks within the root block must be Intra/IBC prediction mode, or Inter prediction mode.

In one embodiment, if all of the blocks within current root block are Inter prediction mode, Inter/IBC mode, and Inter prediction mode for case 1, case 2, and case 3, respectively, then the partition of chroma components follows luma blocks. If all of the blocks within the current root block are Intra prediction mode, Intra prediction mode, and Intra/IBC mode for case 1, case 2, and case 3, respectively, then the chroma components of this root block cannot be further split, which results in multiple luma blocks corresponds to one chroma block.

In another embodiment, a root block is determined and the luma component of this root block can be further partitioned into smaller blocks. According to this embodiment, whether the chroma components of the root block cannot be further split. In this region, the luma blocks can be the same mode or can be a different mode.

In one embodiment, when the chroma components are not allowed to be further split, the chroma residual scaling cannot be applied. In another embodiment, when the chroma components are not allowed to be further split, the chroma residual scaling still can be applied. The positions of the reference luma sample(s) can be different. In one embodiment, the top-left N×M luma prediction samples of the collocated luma block are used. The N and M can be 1, 2, 4, 8, 16, 32, 64, and 128. In another embodiment, the reconstructed top-boundary K reference samples of the current root block are used. In another embodiment, the reconstructed left-boundary K reference samples of the current root block are used. The K can be 1, 2, 4, 8, 16, 32, 64, and 128. In another embodiment, the reconstructed top-left reference sample of the current root block is used.

In another embodiment, when the chroma components are not allowed to be further split and the chroma root block is coded in the Intra mode, the chroma residual scaling cannot be applied. In another example, when the chroma components are not allowed to be further split and the chroma root block is coded in the IBC mode, the chroma residual scaling cannot be applied. In another embodiment, when the chroma components are not allowed to be further split and the chroma root block is coded in the Intra mode, the chroma residual scaling still can be applied. In another example, when the chroma components are not allowed to be further split and the chroma root block is coded in the IBC mode, the chroma residual scaling still can be applied. The positions of the reference luma sample(s) can be different. In one embodiment, the top-left N×M luma prediction samples of the collocated luma block are used. The N and M can be 1, 2, 4, 8, 16, 32, 64, and 128. In another embodiment, the reconstructed top-boundary K reference samples of the current root block are used. In another embodiment, the reconstructed left-boundary K reference samples of the current root block are used. The K can be 1, 2, 4, 8, 16, 32, 64, and 128. In another embodiment, the reconstructed top-left reference sample of the current root block is used.

In another embodiment, when the chroma blocks are in the chroma root block, the chroma residual scaling cannot be applied. In another embodiment, when the chroma blocks are in the chroma root block, the chroma residual scaling still can be applied. The positions of the reference luma sample(s) can be different. In one embodiment, the top-left N×M luma prediction samples of the collocated luma block are used. The N and M can be 1, 2, 4, 8, 16, 32, 64, and 128. In another embodiment, the reconstructed top-boundary K reference samples of the current root block are used. In another embodiment, the reconstructed left-boundary K reference samples of the current root block are used. The K can be 1, 2, 4, 8, 16, 32, 64, and 128. In another embodiment, the reconstructed top-left reference sample of the current root block is used.

The LMCS maps samples in the original domain to a reshaped domain for better data estimation. The mapping curve is approximated by a piece-wise linear (PWL) model. To transform the sample values from the original domain to the reshaped domain, a look-up-table (LUT) is used. The entry number of the LUT is the same as the input sample dynamic range. For example, if a 10-bits input is used, a 1024 entries LUT is used. If a 14-bits input is used, an 8192 entries LUT is used. In the hardware implementation, the cost of such LUT is high. Therefore, the piece-wise linear model can be used. The input can be compared to each of the multiple pieces to find out which piece the input belonging to. In each piece, the corresponding output value can be calculated according to the characteristic of this piece.

Various methods of LMCS are disclosed according to embodiments of the present invention.

Method 1—PCM Mode with LMCS

The LMCS maps samples in the original domain to a reshaped domain for better data estimation. The mapping curve is approximated by piece-wise linear model. To transform the sample values from original domain to reshaped domain, a look-up-table (LUT) is used. The entry number of the LUT is the same as the input sample dynamic range. For example, if a 10-bits input is used, a 1024-entry LUT is used. If a 14-bits input is used, an 8192-entry LUT is used.

In one embodiment, the LMCS is disabled when using Pulse Code Modulation (PCM) coding, which can achieve lossless coding. This is because the mapping process may introduce some numeric rounding or cannot be exactly mapped back to the original values after performing forward mapping and backward mapping, which results in lossy coding. One or multiple high level syntaxes of PCM coding is signaled in SPS/PPS/APS/slice/tile-group/tile/picture level, and are signaled before the LMCS syntaxes according one embodiment of the present invention. When the tile/tile-group/picture/slice/sequence is determined to use PCM coding, the syntax elements related to the LMCS (reshaping tool or the reshaping model) can be skipped, inferred as not used, or can be constrained to be not used (e.g. encoder constraint to disallow the LMCS for the PCM coding).

In another embodiment, if the PCM coding mode is applied in a tile/tile group/slice/picture/sequence-level region, the reshaping still can be applied. However, the mapping table of the forward reshaping and inverse reshaping should be identity mapping, e.g. the input is equal to output, or the mapping function with a line with the slope equal to 1.

In one example, the mapping table can be signaled but the mapping table shall be an identity mapping table. In another example, the mapping table is not signaled. A default identity mapping table is used. The default mapping is a simple identical mapping where the input is equal to output.

In another embodiment, if the CU/PU/TU-level PCM coding and/or transform-quantization bypass mode is applied, the residual or transformed residual should be coded in original domain to achieve PCM coding. For example, the predictors (e.g. Inter mode predictors, Intra mode predictors, Intra block copy mode predictors, palette mode predictors) should also be in the original domain. For Intra prediction or any other prediction mode that uses the neighboring reconstructed samples to generate the predictors (e.g. combined Inter/Intra prediction), the neighboring reconstructed samples are converted to original domain before generating the predictors. In another example, the generated predictors are converted to the original domain if the predictors are generated in the reshaped domain (e.g. the Intra mode predictors). In this example, for Inter mode predictors, it will not pass the forward reshaper to become the reshaped domain predictors when the PCM mode is used. The residual data are coded in the original domain. A syntax is used to specify the domain of the reconstructed CU samples. Therefore, when the CU/PU/TU-level PCM coding and/or transform-quantization bypass mode is applied, if it is predicted using Intra prediction, only neighboring reconstructed samples in the reshaped domain need to be inverse mapped to the original domain.

When the current Intra CU is coded in lossy coding, if the neighboring reconstructed samples are in the original domain, a forward mapping is required. After mapping the neighboring reconstructed samples to the reshaped domain, the Intra prediction samples will be generated using reshaped neighboring reconstructed samples.

In another embodiment, if the current Intra CU is coded in lossy coding, regardless of which domain the neighboring reconstructed samples belong to, the neighboring reconstructed samples are treated as reshaped samples.

In another embodiment, if the CU/PU/TU-level PCM coding and/or transform-quantization bypass mode is applied, the predictors can still be generated in reshaped domain, but the reconstructed samples are not converted by the inverse mapping (to the original domain).

However, the reconstructed samples that are in the reshaped domain shall be PCM to the original samples. For example, for Intra prediction or any other prediction mode that uses the neighboring reconstructed samples to generate the predictors, the neighboring samples do not need to be converted back to the original domain. The reshaped domain neighboring samples can be used to generate the predictors. For Inter prediction, the predictors can be converted through the forward mapping as lossy coding does, or can be not converted through the forward mapping. In another embodiment, the backward mapping can be still applied. However, the mapping table of the backward mapping is identical mapping, such as one to one mapping with the slope equal to 1, or the output is equal to the input.

In another embodiment, if the CU/PU/TU-level PCM coding and/or transform-quantization bypass mode is applied, the forward and backward mappings are disabled or identical mapping is used (for all prediction modes). In another embodiment, the residual/predictor/reconstructed sample can still be coded in reshaped domain. However, there is an encoder constraint or bitstream conformance requirement that the reconstructed samples can be converted to the original domain and the original domain reconstructed samples should be the same as the input samples when PCM mode is applied.

In one embodiment, if the CU/PU/TU-level PCM coding and/or transform-quantization bypass mode is applied, the chroma residual scaling is not applied, or the scaling factor is set as 1, or the scaling factor is limited within a range. For example, the scaling factor shall not be larger than 1 or shall not be smaller than 1. In another embodiment, when transform skip mode is applied, the chroma residual scaling is not applied. In another embodiment, when transform skip mode is applied to the chroma component, the chroma residual scaling is not applied.

In another embodiment, if the CU/PU/TU-level PCM coding and/or transform-quantization bypass mode is applied, the residual or transformed residual should be coded in the reshaped domain, where the output of the mapping table is the same as input. Therefore, the mapping process will not introduce lossy coding.

In another embodiment, if the CU/PU/TU-level PCM mode and/or transform-quantization bypass mode is used, the neighboring reconstructed samples are converted to the original domain. The prediction samples of the current block can still converted by the reshaping.

However, the mapping table of the forward reshaping and inverse reshaping should be a one to one mapping, such as the output is equal to input, or the mapping function corresponds to a line with the slope equal to 1.

Method 2—Derivation of the Inverse Scaling Factor

In one embodiment, the inverse scaling factor can be derived as follows:

InvScaleCoeff[i]=OrgCW*((1<<SCALE_FP_PREC)/lmcsCW[i]).

In this way, division of a non-power-of-2 value (e.g. lmcsCW[i]) can be implemented using a look-up table since the number of possible values of the denominator (e.g. lmcsCW[i]) is limited. The look-up table contains the values of (1<<SCALE_FP_PREC)/lmcsCW[i].

Method 3—LMCS with Default Number of Codewords

In one embodiment, the number of codewords for each bin in the mapped domain (e.g. lmcsCW[i]) can be derived using a default number of codewords instead of using OrgCW, which only depends on the bitdepth of the input data.

In the proposed method, the variables lmcsCW[i] with i=lmcs_min_bin_idx to LmcsMaxBinIdx, are derived according to:

lmcsCW[i]=default_CW+lmcsDeltaCW[i],

where the default_CW is derived at decoder side or signaled from the encoder.

In one embodiment, if the default_CW is derived at decoder side, it can be derived according to the lmcs_min_bin_idx and LmcsMaxBinIdx. If the sum of the number of bins less than lmcs_min_bin_idx and the number of bins larger than LmcsMaxBinIdx is larger than lmcs_min_bin_idx, the default_CW can be adjusted to a value larger than OrgCW.

For example, if the sum of the number of bins smaller than lmcs_min_bin_idx and the number of bins larger than LmcsMaxBinIdx is equal to 2, default_CW is derived as default_CW=OrgCW+A, where A is a positive integer number (e.g. 1, 2, 3 . . . ).

If the sum of the number of bins less than lmcs_min_bin_idx and the number of bins larger than LmcsMaxBinIdx is equal to 0, then the default_CW is equal to OrgCW.

In one embodiment, if the default_CW is signaled, two syntax default_delta_abs_CW and default_delta_sign_CW_flag are signalled before lmcs_delta_cw_prec_minus1.

The variable default_delta_abs_CW represents the absolute difference of the default_CW and OrgCW, and the variable default_delta_sign_CW_flag indicates the delta value is positive or negative. default_delta_sign_CW_flag is only signaled if default_delta_abs_CW is larger than 0.

In one embodiment, if the default_CW is signaled, a syntax default_delta_CW is signaled before lmcs_delta_cw_prec_minus1.

The variable default_delta_CW represents the difference of the default_CW and OrgCW.

Method 4—Reshaping Curve Updates

In one embodiment, the reshaping curve is updated in each frame, or in every other frame.

Chroma Scaling with VPDU Constraints

A picture can be divided into several non-overlapped M×N blocks. These M×N non-overlapped blocks as processing data units are called VPDUs. The M and N can be 64, or any predefined or signaled value, or a value related to maximum transform block size.

In one embodiment, for chroma component, the chroma residual scaling uses the reference luma reconstructed samples outside current VPDU, for example, the previously coded VPDU.

In one embodiment, the reference luma samples can be one or multiple region. For example, the reference samples are the K×L block outside current VPDU. The K and L can be 2, 4, 8, 16, or 32. In detail, size of the current VPDU is equal to min(CtbSizeY, 64), and the number of reference luma samples at top boundary and left boundary are equal to min(CtbSizeY, 64), respectively according to this embodiment. The variable CtbSizeY specifies the luma width and luma height of the luma coding tree block.

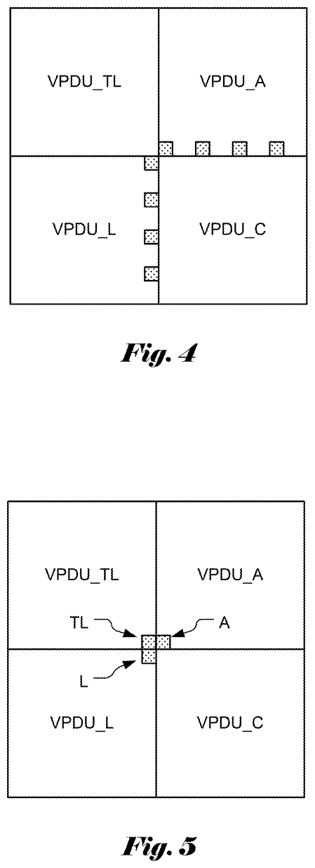

In another embodiment, the reference reconstructed luma samples are along the VPDU top boundary or left boundary or both as shown in FIG. 4. The number of reference luma samples is a power of 2 value.

In another embodiment, the reference reconstructed luma sample is only one sample value. In one embodiment, the position can be the top-left position of the L-shape boundary of the current VPDU, such as the TL position in FIG. 5. In another embodiment, the position of the reference sample can be the above position of the current VPDU, such as the A position in FIG. 5.

In another embodiment, the position of the reference sample can be the left position of the current VPDU, such as the L position in FIG. 5.

In another embodiment, the chroma scaling is only derived once in each VPDU and the scaling factor is derived by the first CU in each VPDU. In detail, size of a VPDU is equal to Min(CtbSizeY, 64), and for all blocks in a Min(CtbSizeY, 64) by Min(CtbSizeY, 64) region (i.e., in a same VPDU), the reference luma samples used to derive the chroma scaling factor are the same according to this embodiment. The variable CtbSizeY specifies the luma width and luma height of the luma coding tree block.

In another embodiment, a reference coding unit (CU) for the chroma scaling is derived according to the VPDU corresponding to the current blocks (for example, the chroma scaling is always derived by the first CU in the VPDU even though the chroma scaling is not applied to that CU). In detail, size of a VPDU is equal to Min(CtbSizeY, 64), and the reference CU covers the top-left position of the current VPDU according to this embodiment. The reference luma samples include the Min(CtbSizeY, 64) reconstructed luma samples along the reference CU's top boundary and the Min(CtbSizeY, 64) luma reconstructed samples along the reference CU's left boundary. In another embodiment, if chroma scaling is not applied to the first CU in the current VPDU, the scaling factor is set to a default value. In one embodiment, the default value is equal to (1<<PREC), where PREC is the prediction for chroma scaling.

In another embodiment, the chroma scaling factor is shared in the picture/slice level.

In another embodiment, the chroma scaling factor is shared in the APS level In other words, for each signaled mapping curve, one chroma scaling factor is derived. In one example, the derivation of the chroma scaling factor for each reshaping curve is done by averaging the scaling factor in all intervals (pieces). In another embodiment, the scaling factor is derived by selecting the majority of the scaling factor in all intervals (pieces). In another embodiment, the scaling factor is derived by directly divide the difference between the maximum luma sample and the minimum luma sample with the difference between the maximum luma sample in the reshaped domain and the minimum luma sample in the reshaped domain.

Luma Residual with Reduced Latency

Instead of mapping luma prediction samples, the mapping can be applied to the luma residual only. In other words, the prediction samples of the luma component are in the original domain, and the residual of the luma component will be scaled by a scaling factor. The scaling factor is derived by referencing luma prediction samples in different positions, or in different ways.

The above methods proposed for chroma scaling can also be applied to luma residual scaling.

In another embodiment, the scaling factor is the average of two scaling factors of two consecutive intervals.

In one embodiment, the scaling factor used for both luma residual scaling and chroma residual scaling are the same.

Signaling Chroma Scaling Factors

Instead of implicitly deriving the chroma scaling factor at decoder side, an embodiment of the present invention signals the chroma scaling factor at TB, TU, CU, CTU, VPDU, slice level, brick level, or APS level.

In one embodiment, one or more chroma scaling factors are signaled in one APS.

In one embodiment, if the chroma scaling factor is signaled at the TU level and if both the Cbfs (coded block flags) of Cb and Cr are equal to 0, then the chroma scaling factor is not signaled.

In another embodiment, if the chroma scaling factor is signaled at the TU level and if the root Cbf is equal to 0, then the chroma scaling factor is not signaled.

In one embodiment, if the chroma scaling factor is signaled at TB level for chroma Cb component and if the Cbf of Cb is equal to 0, then the chroma scaling factor is not signaled; for chroma Cr component, if the Cbf of Cr is equal to 0, then the chroma scaling factor is not signaled.

In some embodiment, video encoders have to follow the foregoing syntax design so as to generate the legal bitstream, and video decoders are able to decode the bitstream correctly only if the parsing process is complied with the foregoing syntax design. When the syntax is skipped in the bitstream, encoders and decoders should set the syntax value as the inferred value to guarantee the encoding and decoding results are matched.

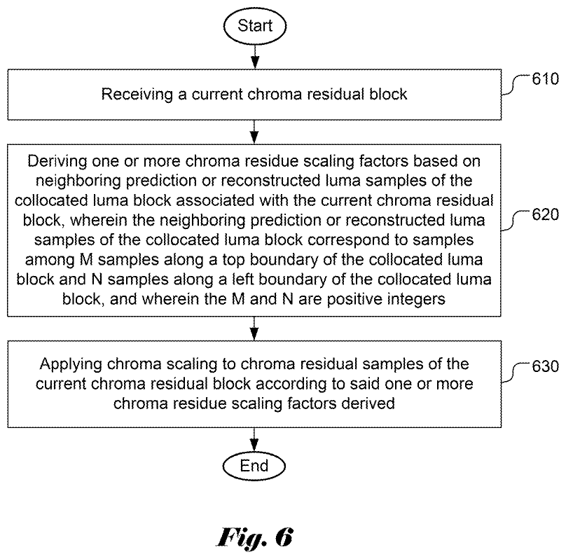

FIG. 6 illustrates a flowchart of an exemplary decoding system for deriving one or more chroma residue scaling factors based on neighboring prediction or reconstructed luma samples of the collocated luma block according to an embodiment of the present invention. The steps shown in the flowchart, as well as other following flowcharts in this disclosure, may be implemented as program codes executable on one or more processors (e.g., one or more CPUs) at the encoder side and/or the decoder side. The steps shown in the flowchart may also be implemented based hardware such as one or more electronic devices or processors arranged to perform the steps in the flowchart. According to this method, a current chroma residual block is received in step 610. One or more chroma residue scaling factors are derived based on neighboring prediction or reconstructed luma samples of the collocated luma block associated with the current chroma residual block in step 620, wherein the neighboring prediction or reconstructed luma samples of the collocated luma block correspond to samples among M samples along a top boundary of the collocated luma block and N samples along a left boundary of the collocated luma block, and wherein the M and N are positive integers. Chroma scaling is then applied to chroma residual samples of the current chroma residual block according to said one or more chroma residue scaling factors in step 630.

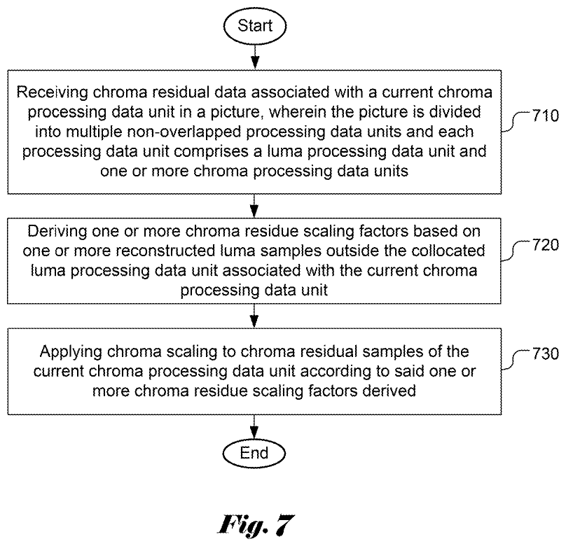

FIG. 7 illustrates a flowchart of another exemplary decoding system for deriving one or more chroma residue scaling factors based on one or more reconstructed luma samples outside the collocated luma processing data unit according to an embodiment of the present invention. According to this method, chroma residual data associated with a current chroma processing data unit in a picture are received in step 710, wherein the picture is divided into multiple non-overlapped processing data units and each processing data unit comprises a luma processing data unit and one or more chroma processing data units. One or more chroma residue scaling factors are derived based on one or more reconstructed luma samples outside the collocated luma processing data unit associated with the current chroma processing data unit in step 720. Chroma scaling is applied to chroma residual samples of the current chroma processing data unit according to said one or more chroma residue scaling factors in step 730.

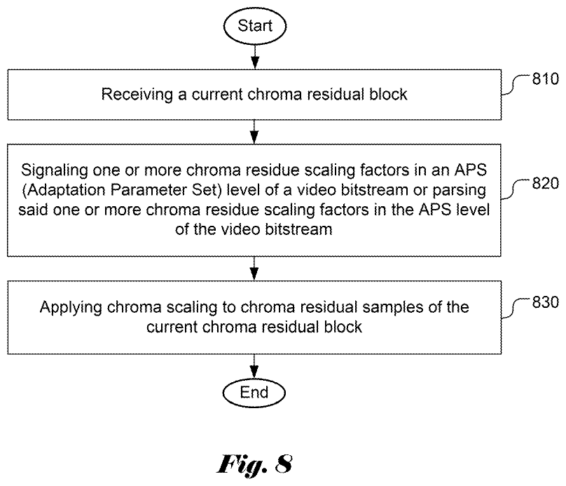

FIG. 8 illustrates a flowchart of an exemplary coding system, where one or more chroma residue scaling factors are signaled in an APS (Adaptation Parameter Set) level of a video bitstream in an encoder side or parsed from the APS level of the video bitstream at a decoder side according to an embodiment of the present invention. According to this method, a current chroma residual block is received in step 810. One or more chroma residue scaling factors are signaled in an APS (Adaptation Parameter Set) level of a video bitstream or said one or more chroma residue scaling factors are parsed in the APS level of the video bitstream in step 820. Chroma scaling is applied to chroma residual samples of the current chroma residual block in step 830.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video decoding, the method comprising:
receiving chroma residual data associated with a current chroma processing data unit in a picture, wherein the picture is divided into multiple non-overlapped processing data units and each processing data unit comprises a luma processing data unit and one or more chroma processing data units;
deriving one or more chroma residue scaling factors based on one or more reconstructed luma samples outside a collocated luma processing data unit associated with the current chroma processing data unit; and
applying chroma scaling to chroma residual samples of the current chroma processing data unit according to said one or more chroma residue scaling factors derived.

2. The method of claim 1, wherein said one or more reconstructed luma samples outside the collocated luma processing data unit correspond to one or more reconstructed luma samples of one or more previously coded luma processing data units.

3. The method of claim 2, wherein said one or more reconstructed luma samples of said one or more previously coded luma processing data units correspond to one or more reconstructed luma samples along a top boundary of the collocated luma processing data unit, one or more reconstructed luma samples along a left boundary of the collocated luma processing data unit, or both.

4. The method of claim 1, wherein the luma size of one or multiple non-overlapped processing data units is equal to Min(CtbSizeY, 64) by Min(CtbSizeY, 64), and wherein CtbSizeY specifies luma width and luma height of a luma coding tree block.

5. An apparatus of video decoding, the apparatus comprising one or more electronic circuits or processors arranged to:
receive chroma residual data associated with a current chroma processing data unit in a picture, wherein the picture is divided into multiple non-overlapped processing data units and each processing data unit comprises a luma processing data unit and one or more chroma processing data units;
derive one or more chroma residue scaling factors based on one or more reconstructed luma samples outside a collocated luma processing data unit associated with the current chroma processing data unit; and
apply chroma scaling to chroma residual samples of the current chroma processing data unit according to said one or more chroma residue scaling factors derived.

6. (canceled)

7. (canceled)

8. (canceled)

9. (canceled)

10. (canceled)

11. (canceled)

12. A method of video coding, the method comprising:
receiving a current chroma residual block;
signaling one or more chroma residue scaling factors in an APS (Adaptation Parameter Set) level of a video bitstream or parsing said one or more chroma residue scaling factors in the APS level of the video bitstream; and
applying chroma scaling to chroma residual samples of the current chroma residual block.

13. An apparatus of video decoding, the apparatus comprising one or more electronic circuits or processors arranged to:
receive a current chroma residual block;
signal one or more chroma residue scaling factors in an APS (Adaptation Parameter Set) level of a video bitstream or parsing said one or more chroma residue scaling factors from the APS level of the video bitstream; and
apply chroma scaling to chroma residual samples of the current chroma residual block.

14. (canceled)

15. (canceled)

16. (canceled)

17. (canceled)

18. (canceled)

19. (canceled)

20. (canceled)
